(19) United States
(12) Patent Application Publication
(10) Pub. No.: US 2019/0296687 A1
(43) Pub. Date: Sep. 26, 2019

(54) STRUCTURAL BEAM FOR SOLAR TRACKER

(71) Applicant: NEXTracker Inc., Freemont, CA (US)

(72) Inventors: Jacob M. Morin, Phoenix, AZ (US); Stuart Upfill-Brown, San Francisco, CA (US)

(73) Assignee: NEXTracker Inc., Freemont, CA (US)

(21) Appl. No.: 15/933,722

(22) Filed: Mar. 23, 2018

(51) Int. Cl. H02S 20/32; H02S 20/10; E04B 1/24; E04B 1/21

(52) U.S. Cl. CPC H02S 20/32; H02S 20/10; E04B 1/2403; E04B 2001/2457; E04B 2001/2415; E04B 2001/2418; E04B 1/215

(57) ABSTRACT

A solar system is provided and includes a solar array and a support structure configured to support the solar array. The support structure includes structural beam which includes an upper plate, a lower plate that is disposed opposite to the upper plate, a first side plate interposed between the upper and lower plates, and a second side plate interposed between the upper and lower plates and spaced apart from the first side plate. Each of the upper and lower plates is fixedly coupled to the first and second plates by a plurality of joints formed by clinching.

### BACKGROUND

### Technical Field

The present disclosure relates to solar systems, and more particularly, to structural beams for use with solar tracker actuating systems for adjusting the orientation of the solar system to track the location of the sun.

### Description of Related Art

Solar cells and solar panels are most efficient in sunny conditions when oriented towards the sun at a certain angle. Many solar panel systems are designs in combination with solar trackers, which follow the sun's trajectory across the sky from east to west in order to maximize the electrical generation capabilities of the systems. The relatively low energy produced by a single solar cell requires the use of thousands of solar cells, arranged in an array, to generate energy in sufficient magnitude to be usable, for example as part of an energy grid. As a result, solar trackers have been developed that are quite large, spanning hundreds of feet in length.

Adjusting massive solar trackers requires power to drive the solar array as it follows the sun. As will be appreciated, the greater the load, the greater the amount of power necessary to drive the solar tracker. An additional design constraint of such systems is the rigidity required to accommodate the weight of the solar arrays and at times significant wind loading.

Further, the torsional excitation caused by wind loading exerts significant force upon the structure for supporting and the mechanisms for articulating the solar tracker. As such, increases in the size and number of components to reduce torsional excitation are required at varying locations along the length of the solar tracker. As can be appreciated, solar structures are typically composed of lightweight framing designed to reduce the overall cost of the product. As such, current methods for producing light weight steel members from cold formed steel sheet result in a single thickness of material throughout the entire cross-section. This leaves current designers choosing between a weight optimized or a stiffness optimized system, essentially choosing between cost and reliability.

As noted above, tracker systems rely on torsional rigidity of the framing members to ensure proper operation. This rigidity is best achieved through the use of a tube or pipe. Current manufacturing methods for cold formed tube and pile only allow for the use of one steel thickness. In addition, closed shapes are typically welded, which may lead to distortion in final shape, limiting the number of operations that may be performed on the sheet prior to beam fabrication. The present disclosure seeks to address the shortcomings of prior tracker systems.

### SUMMARY

The present disclosure is directed to a solar system including a solar array and a support structure configured to support the solar array. The support structure includes a structural beam that includes an upper plate, a lower plate disposed opposite to the upper plate, a first side plate interposed between the upper and lower plates, and a second side plate interposed between the upper and lower plates and spaced apart from the first side plate. Each of the upper and lower plates is fixedly coupled to the first and second side plates by a plurality of joints formed by clinching.

In aspects, the solar system may include a base configured to support the support structure.

In certain aspects, the base may be configured to rotatably support the support structure.

In other aspects, the base may be formed from the structural beam.

In certain aspects, the solar system may include a torque tube configured to support the support structure on the base.

In aspects, the torque tube may be configured to rotatably support the support structure on the base.

In other aspects, the torque tube may be formed from the structural beam.

In aspects, the upper plate, lower plate, first side plate, and second side plate may be formed from the same material.

In certain aspects, at least one of the upper plate, lower plate, first side plate, and second side plate may be formed from a different material than the remaining upper plate, lower plate, first side plate or second side plate.

In other aspects, each joint of the plurality of j oints may form a mushroom profile.

In aspects, each joint of the plurality of j oints may form a rectangular profile.

In certain aspects, a portion of the joints of the plurality of joints may form a mushroom profile and a portion of the joints of the plurality of joints may form a rectangular profile.

In other aspects, at least one of the upper plate, lower plate, first side plate, and second side plate may include a varying thickness.

In aspects, at least one of the upper plate, lower plate, first side plate, and second side plate may be pre-coated with a corrosion protective material prior to being coupled to one another by clinching.

### BRIEF DESCRIPTION OF THE DRAWINGS

Various aspects and features of the present disclosure are described hereinbelow with reference to the drawings, wherein:

FIG. 1 is a top, perspective view of a structural beam provided in accordance with the present disclosure;

FIG. 2 is an enlarged view of the area of detail indicated in FIG. 1;

FIG. 3 is a side view of the structural beam of FIG. 1;

FIG. 4 is a top view of the structural beam of FIG. 1;

FIG. 5 is cross-sectional view of the structural beam of FIG. 1;

FIG. 6 is a side view of a solar tracking system for which the structural beam of FIG. 1 may be utilized;

FIG. 7 is a bottom, perspective view of the solar tracking system of FIG. 6;

FIG. 8 is an enlarged view of the area of detail indicated in FIG. 7;

FIG. 9 is a bottom, perspective view of a solar tracking system showing a plurality of torque tubes;

FIG. 10 is perspective view of another embodiment of a solar tracking system for which the structural beam of FIG. 1 may be utilized; and

FIG. 11 is a perspective view of the solar tracking system of FIG. 1, shown with parts separated.

### DETAILED DESCRIPTION

The present disclosure is directed to a structural beam for use with solar tracking systems and methods for manufacturing the same. The structural beam includes a plurality of plates which may be oriented in any suitable manner to provide the requisite strength for the application in which the structural beam is to be utilized. The each plate of the plurality of plates is fixedly joined to one another using a cold forming technique such as clinching. In this manner, a punch and die is utilized to join a portion of adjacent plates to one another. The location and number of joints may depend on the requirements of the application in which the structural beam is to be utilized. In aspects, one or more of the components of the structural beam may include a varying thickness over its length or width and may be pre-coated with a corrosion protective material prior to being joined.

It is contemplated that the structural beam may be utilized in the construction of a solar tracking system, although it is contemplated that the structural beam may be used with suitable any solar system, such as a fixed solar system. In particular, the structural beam may be utilized in the support structure, the base, torque tubes, and other structural members. As can be appreciated, the use of clinching eliminates the need for other joining techniques, such as welding, mechanical fasteners, adhesives, or the like. Further, clinching reduces the need to perform time consuming and wasteful preparation (e.g., drilling, grinding, etc.) before joining materials together. An added benefit of using clinching to joint materials together is the ability to create any suitable beam profile, the ability to join differing materials to one another, portions of the structural beam may include varying thicknesses, and the various components of the structural beam may be pre-coated with paint or other corrosion protective materials without concern of damaging the coating during clinching.

Embodiments of the present disclosure are now described in detail with reference to the drawings in which like reference numerals designate identical or corresponding elements in each of the several views. In the drawings and in the description that follows, terms such as front, rear, upper, lower, top, bottom, and similar directional terms are used simply for convenience of description and are not intended to limit the disclosure. In the following description, well-known functions or constructions are not described in detail to avoid obscuring the present disclosure in unnecessary detail.

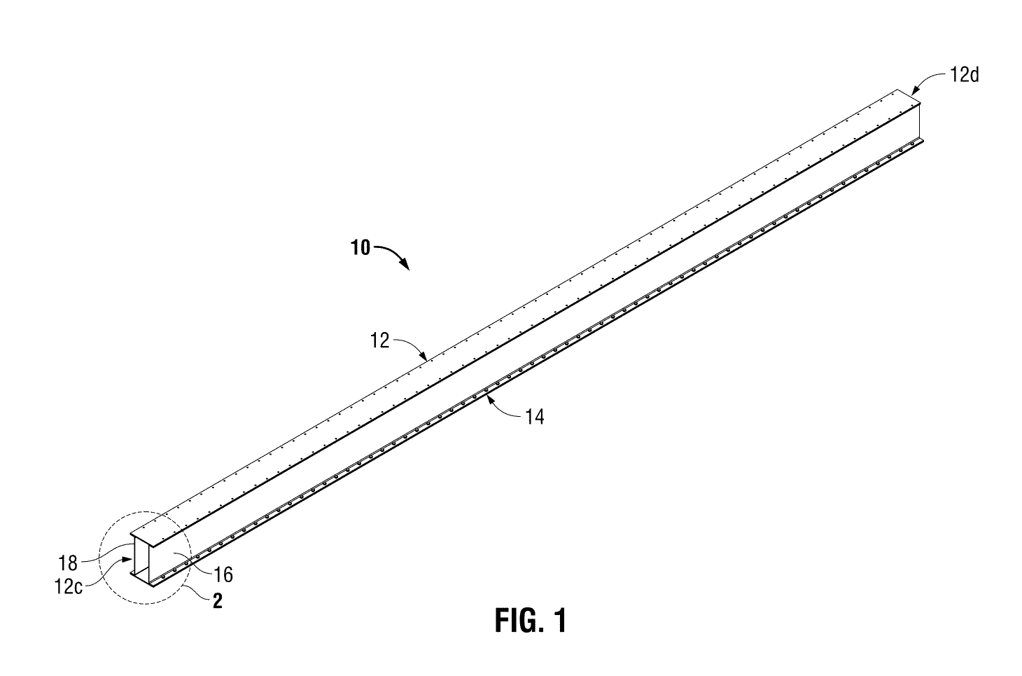

With reference to FIGS. 1-5, a structural beam for use with a solar tracking system is provided in accordance with the present disclosure and generally identifying by reference numeral 10. Although generally described as being utilized in a solar tracking system, it is contemplated that the structural beam 10 may be utilized in any suitable tracking system, such as a fixed solar system or the like.

The structural beam 10 defines a generally rectangular profile having an upper plate 12, a lower plate 14 disposed opposite thereto and spaced apart therefrom, a first side plate 16, and a second side plate disposed opposite to the first side plate, the first and second side plates interposed between the upper and lower plates 12, 14. Although generally described as defining a generally rectangular profile and including an upper plate 12, lower plate 14, a first side plate 16, and a second side plate 18, it is contemplated that the structural beam 10 may define any suitable profile (e.g., I-beam, C-channel, U-channel, Box, etc.) and may include any number of plates (e.g., 2, 3, 4, 5, etc.) depending upon the needs of the structural beam 10.

The upper and lower plates 12, 14 are substantially similar to one another and therefore only the upper plate 12 will be described in detail herein in the interest of brevity. The upper plate 12 includes an inner surface 12a and an outer surface 12b disposed opposite thereto, each of the inner and outer surfaces extending between opposed end portions 12c and 12d and opposed side surfaces 12e and 12f Although generally illustrated as having a rectangular profile, it is contemplated that the upper plate 12 may include any suitable profile, and the upper and lower plates 12 and 14 may include the same or different profiles.

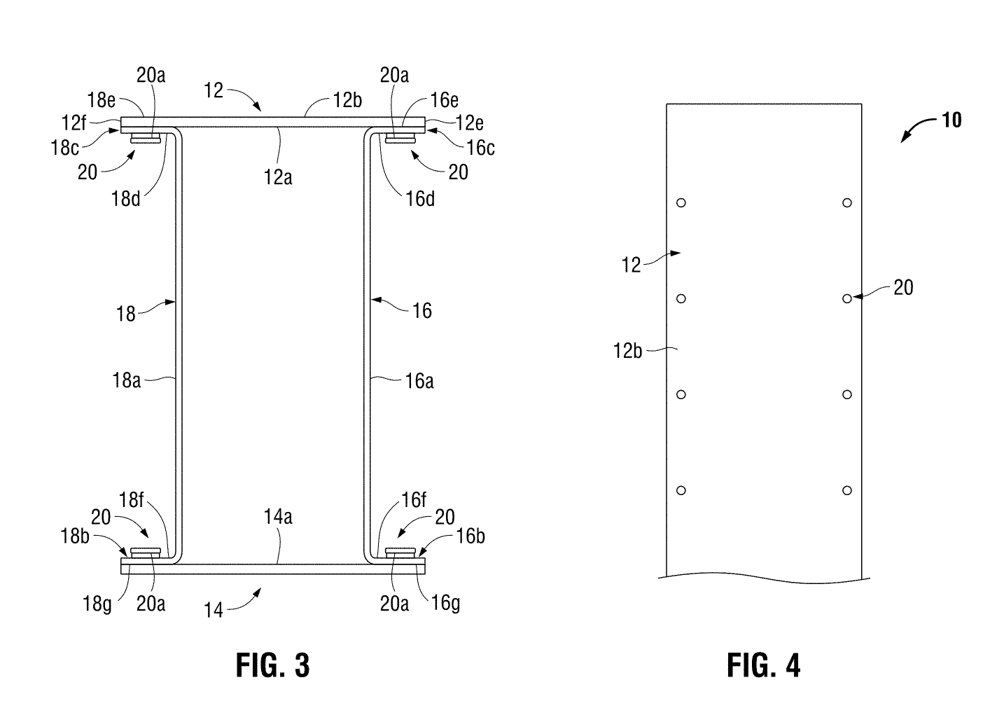

The first and second side plates 16, 18 are substantially similar to one another and therefore only the first side plate 16 will be described herein in the interest of brevity. The first side plate 16 defines a generally C-shaped profile having a planar side surface 16a and a pair of tabs 16b and 16c extending perpendicular therefrom. Each tab of the pair of tabs 16b, 16c is spaced apart from and extends parallel to one another. The pair of tabs 16b, 16c defines a corresponding inner and outer surface 16d, 16e and 16f, 16g respectively. As illustrated in FIG. 3, the outer surfaces 16e, 16g of each tab of the pair of tabs 16b, 16c, respectively, is configured to abut an inner surface 12a, 14a of the upper and lower plates 12, 14 respectively.

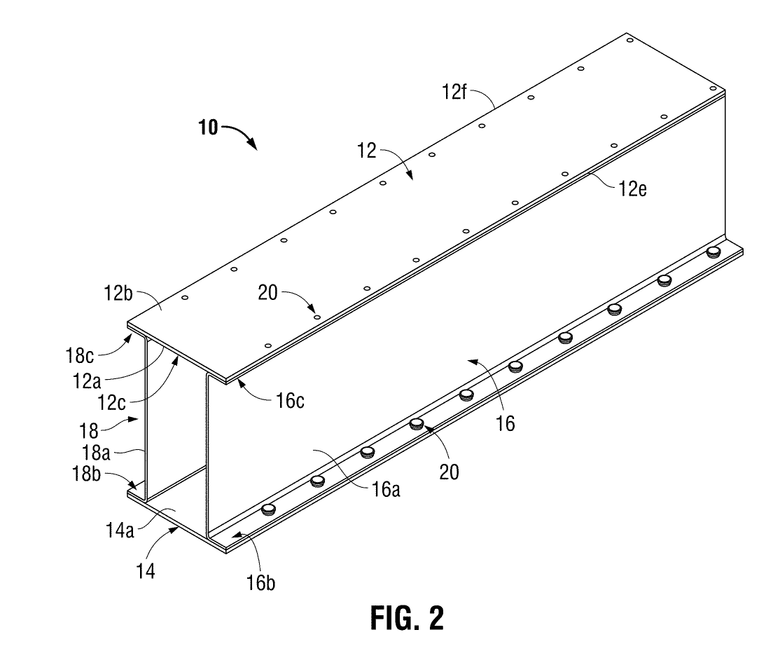

As illustrated in FIGS. 2 and 3, the first and second side plates 16, 18 are disposed in spaced relation to one another and the pairs of tabs 16b, 16c and 18b, 18c are co-planar. Each of the upper and lower plates 12, 14 is disposed on a respective tab 16b, 16c, 18b, 18c such that the inner surfaces 12a, 14a of the upper and lower plates 12, 14 abut an outer surface 16e, 16g and 18e, 18g, respectively.

Using a cold forming process such as clinching or press-joining, the first and second side plates 16, 18 are fixedly coupled to the upper and lower plates 12, 14. The clinching process is substantially similar for each location the process is utilized, and thus, only one joint 20 will be described in detail herein in the interest of brevity.

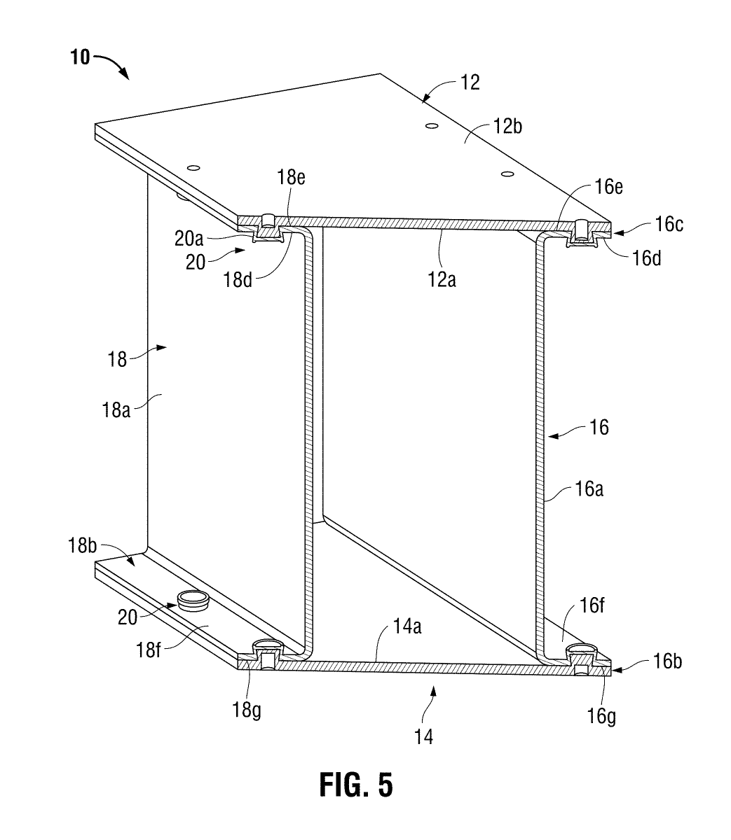

Initially, the inner surface 12a of the upper plate 12 is placed on the outer surface 16e of the tab 16b of the side plate 16 such that the upper plate 12 is supported thereon. A die is placed against the inner surface 16d of the tab 16b of the side plate 16 and held in place using any suitable means that is capable of inhibiting movement of the die relative to the side plate 16. Next, a punch is placed adjacent the outer surface 12b of the upper plate and is oriented in a manner such that it is concentric with the die. At this point, the punch is driven into the upper surface 12b of the upper plate 12 using any suitable means. The punch is continued to be driven into the upper surface 12b such that the upper plate 12 is driven into the tab 16b of the side plate 16. Continued driving of the punch causes the tab 16b to be displaced within the die, at which point the upper plate 12 is likewise driven into a cavity formed by the tab 16b within the die. As illustrated in FIGS. 3 and 5, the portions of the upper plate 12 and the tab 16b that have been joined using the punch and die form a generally mushroom shaped profile 20a, thereby inhibiting the upper plate 12 from separating from the tab 16b. Although generally illustrated as forming a mushroom shaped profile 20a (e.g., round configuration), it is contemplated that the punch and die may be any suitable profile, such as rectangular, oval, square, etc., depending on the type of material being joined or the needs of the structural beam 10.

As can be appreciated, the number of joints 20 that are formed may vary depending upon the needs of the structural beam 10 and the location in which it is being employed. Specifically, a greater number of joints 20 may be utilized where greater strength is required, and a lower number of joints 20 may be utilized where less strength is required. Further, the location at which each joint is located may be varied (e.g., in a transverse direction) depending upon the torsion or bending loads being applied to the structural beam 20. In this manner, the joints 20 may be placed at any suitable location on the structural beam 10.

It is contemplated that the structural beam 10 may be formed using any suitable material or combinations of materials, such as metallic materials (e.g., steel, aluminum, copper, magnesium, titanium, etc.) or non-metallic materials (e.g., polymers, fiber-reinforced plastics, composites, wood-metal composites, etc.). In embodiments, the upper and lower plates 12, 14 may be formed from a metallic material and the first and second side plates 16, 18 may be formed from a non-metallic material, or vice versa. It is contemplated that each of the upper and lower plates 12, 14 and first and second side plates 16, 18 may be formed from the same or different materials.

In embodiments, each of the upper plate 12, lower plate 14, and first and second side plates 16, 18 may include varying thicknesses to accommodate varying loads supported by the structural beam 10 along its length. In this manner, the thickness of the upper plate 12, lower plate 14, and first and second side plates 16, 18 may be thinner where strength is not required, and the thickness may be thicker where it would be most efficient to use (e.g., a higher load). As can be appreciated, varying the thickness of the upper plate 12, lower plate 14, and first and second side plates 16, 18 helps reduce the respective weight of each plate while increasing stiffness. It is also envisioned that each of the upper plate 12, lower plate 14, and first and second side plates 16, 18 may be coated with a corrosive protective material, such as paint, anodizing, galvanizing, etc. before joining. As can be appreciated, joining pre-coated upper and lower plates 12, 14 to pre-coated first and second side plates 16, 18 may be accomplished using the clinching method without concern over damaging the protective material during joining.

As can be appreciated, the use of clinching eliminates the need for other joining techniques, such as welding, mechanical fasteners, adhesives, or the like. Further, clinching reduces the need to perform time consuming and wasteful preparation (e.g., drilling, grinding, etc.) before joining materials together. An added benefit of using clinching to join materials together is the ability to create any suitable beam profile the ability to join differing materials to one another. Further, the use of clinching enables each plate to be processed (e.g., formed to final shape, holes, etc.) before joining with minimal to no concern of distorting the final shape of each plate.

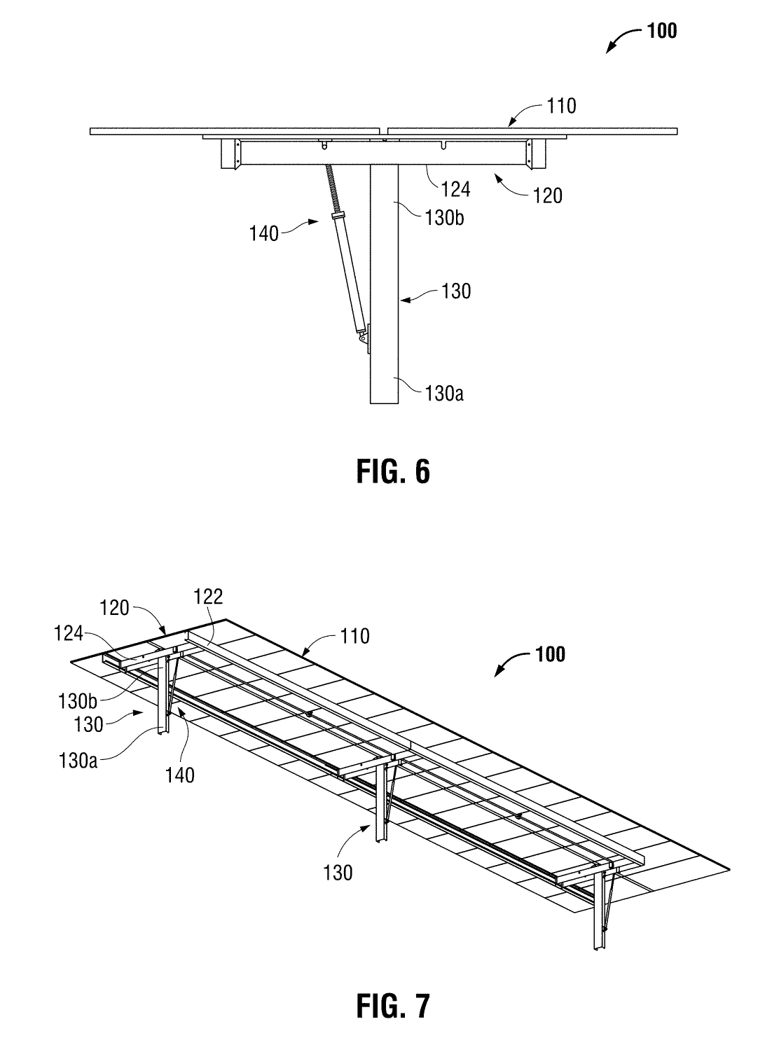

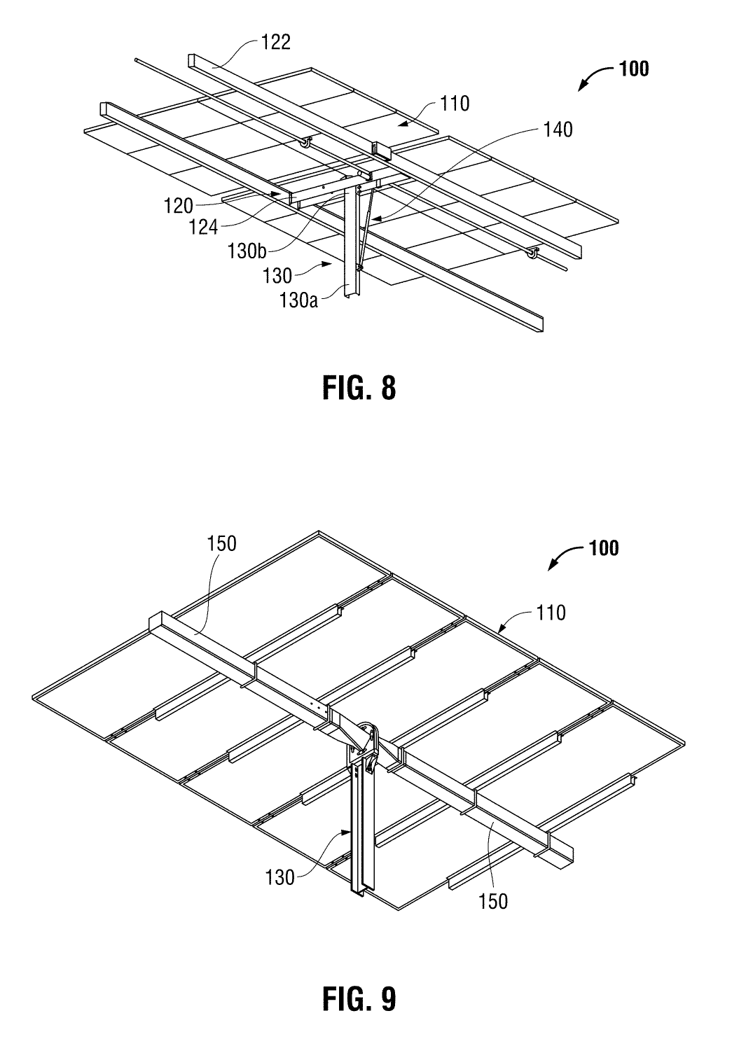

With reference to FIGS. 6-9, it is contemplated that the structural beam 10 may be employed in a solar tracking system 100. The solar tracking system includes a solar array 110, a support structure 120 that is configured to support the solar array 110, a base 130 that is configured to rotatably support the support structure 120, and an articulation system 140 that is configured to articulate the solar array 110 and support structure 120 relative to the base 130.

The solar array 110 is supported on the support structure 120 which includes a pair of parallel beams 122 disposed in spaced relation to one another and extending along a length of the solar tracking system 100. The support structure 120 includes pairs of transverse beams 124 which are disposed parallel to one another and are spaced apart to receive a portion of the base 130, such that the support structure 120 may articulate with the base 130 not interfering with articulation of the support structure 120 relative thereto.

The base 130 includes a first end portion 130a that is configured to be anchored into the ground or to a suitable structure and a second, opposite end portion 130b that is configured to rotatably support the support structure 120. The base 130 supports a portion of the articulation system 140, such that the articulation system can act against the base 130 and cause the support structure 120 to articulate about the base 130 and adjust the orientation of the solar array 110 relative to the sun. With reference to FIG. 9, the solar tracking system 100 may include a plurality of torque tubes 150 that is configured to transmit torsional load across the solar array 20 and inhibit twist of the solar array 20 as the solar array 20 is rotated.

It is contemplated that one or both of the parallel beams 122, one or more transverse beams of the pairs of transverse beams 124, and one or more of the torque tubes 150 be formed of the structural beam 10 described herein. As can be appreciated, the profile and number of joints utilized in the structural beam may be customized to accommodate the structural, dimensional, and environmental needs of each particular beam.

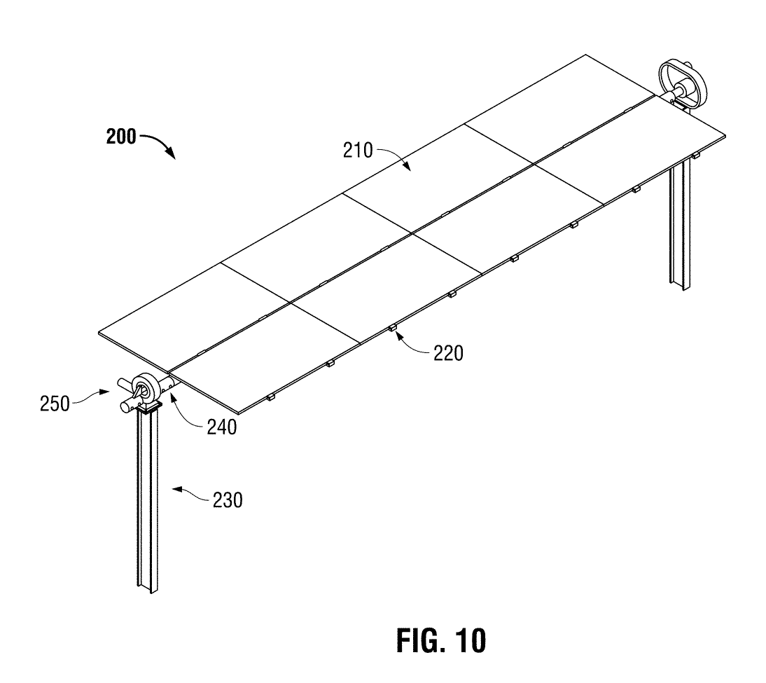

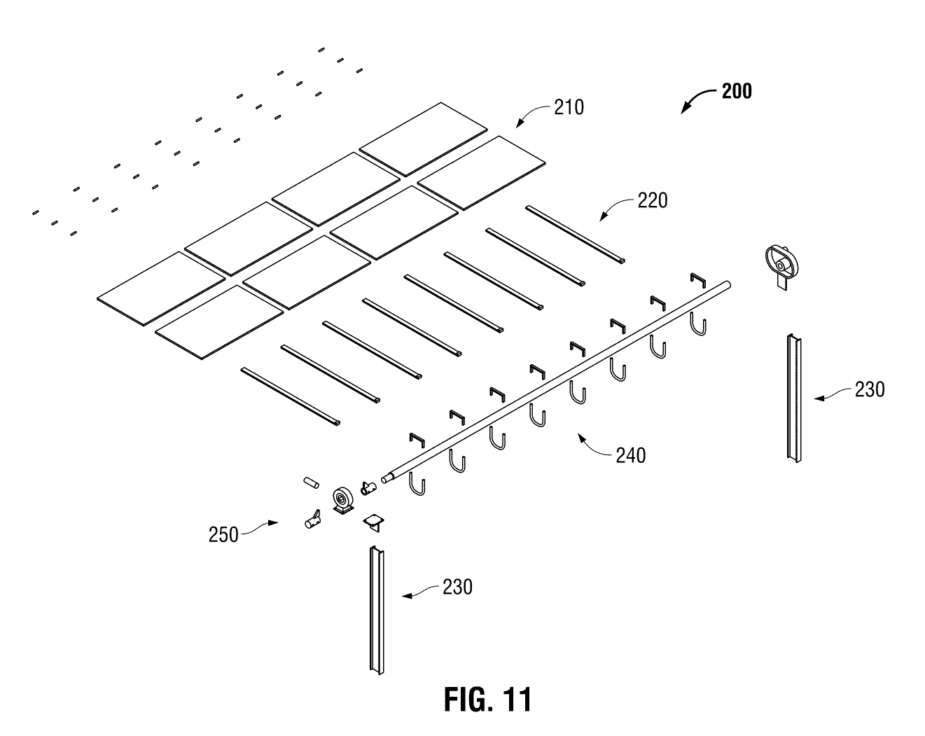

FIGS. 10 and 11 illustrate another embodiment of a solar tracking system in which the structural beam 10 may be utilized and is generally identified by reference numeral 200. The solar tracking system 200 is a horizontal balanced solar tracker and includes a solar array 210, a plurality of support beams 220 configured to support the solar array 210, a plurality of bases 230 configured to rotatably support a torque tube 240 that is configured to support the plurality of support beams 220, and an articulation system 250 configured to articulate the solar array 210. It is contemplated that one or more of the plurality of support beams 220, the plurality of bases 230, and the torque tube 240 may be formed of the structural beam 10. As can be appreciated, a wall thickness of the torque tube 240 may vary along its length to accommodate varying torsional loads at specific locations. In this manner, a torque tube 240 formed from the structural beam 10 described herein enables greater flexibility in accommodating the torsional stiffness, weight, and bending stiffness required to adequately support the solar array 210 and its associated structure.

For a detailed description of exemplary solar tracking systems that the structural beam 10 may be utilized, reference may be made to U.S. Pat. No. 9,466,749, titled “Balanced Solar Tracker Clamp,” to Au, U.S. patent application titled “Multiple Actuator System for Solar Tracker,” filed Mar. 23, 2018 to Kresse et al., and U.S. Pat. No. 9,905,717, titled “Horizontal Balanced Solar Tracker,” the entire contents of each of which is incorporated herein by reference.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments.

What is claimed is:

1. A solar system, comprising:
a solar array; and
a support structure configured to support the solar array, wherein the support structure includes a structural beam, comprising:
an upper plate;
a lower plate disposed opposite to the upper plate;
a first side plate interposed between the upper and lower plates; and
a second side plate interposed between the upper and lower plates and spaced apart from the first side plate,
wherein each of the upper and lower plates is fixedly coupled to the first and second side plates by a plurality of joints formed by clinching.

2. The solar system according to claim 1, wherein the solar tracking system includes a base configured to support the support structure.

3. The solar system according to claim 1, wherein the base is configured to rotatably support the support structure.

4. The solar system according to claim 2, wherein the base is formed from the structural beam.

5. The solar system according to claim 2, wherein the solar system includes a torque tube configured to support the support structure on the base.

6. The solar according to claim 5, wherein the torque tube is configured to rotatably support the support structure on the base.

7. The solar system according to claim 5, wherein the torque tube is formed from the structural beam.

8. The solar system according to claim 1, wherein the upper plate, lower plate, first side plate, and second side plate are formed from the same material.

9. The solar system according to claim 1, wherein at least one of the upper plate, lower plate, first side plate, and second side plate is formed from a different material than the remaining upper plate, lower plate, first side plate, or second side plate.

10. The solar system according to claim 1, wherein each joint of the plurality of joints forms a mushroom profile.

11. The solar system according to claim 1, wherein each joint of the plurality of joints forms a rectangular profile.

12. The solar system according to claim 1, wherein a portion of the joints of the plurality of joints form a mushroom profile and a portion of the joints of the plurality of joints form a rectangular profile.

13. The solar system according to claim 1, wherein at least one of the upper plate, lower plate, first side plate, and second side plate includes a varying thickness.

14. The solar system according to claim 1, wherein at least one of the upper plate, lower plate, first side plate, and second side plate is pre-coated with a corrosion protective material prior to being coupled to one another by clinching.
